(19) United States
(12) Patent Application Publication
(10) Pub. No.: US 2007/0127401 A1
(43) Pub. Date: Jun. 7, 2007

(54) Optical wireless connecting terminal comprising an extended infrared source

(75) Inventors: Philippe Guignard, Pleumeur-Bodou (FR); Adrian-Mircea Mihaescu, Lannion (FR); Pascal Besnard, Lannion (FR); Pierre-Noel Favennec, Lannion (FR)

Correspondence Address: Thomas Langer;Cohen Pontani Lieberman & Pavane, Suite 1210, 551 Fifth Avenue, New York, NY, 10176, US

(73) Assignee: France Telecom, Paris (FR)

(21) Appl. No.: 10/578,534

(22) PCT Filed: Nov. 3, 2003
(86) PCT No.: PCT/FR03/03267

§ 371 Date: May 3, 2006

(51) Int. Cl. H04L 27/00; H04B 7/00

(52) U.S. Cl. 370/310; 375/295

(57) ABSTRACT

A base for wireless connection of terminals to a communications network, said base including a transmit/receive unit adapted to exchange information with a remote terminal also provided with a transmit/receive unit. The transmit/receive unit of the base includes a transmitter including an extended infrared light source.

The present invention relates to wireless connections to communications networks.

To be more precise, the present invention relates to high bit rate wireless connections between a user equipment (user terminal) and a fixed base connected to a telecommunications or data communications network.

When traveling (roaming), more and more users of mobile terminals (mobile telephones, portable computers, PDAs, etc.) need to connect on a one-off basis or regularly to a fixed communications network or to an onboard communications network (then considered by the user as being “locally fixed”). To facilitate these roaming connections, operators have had to extend their networks, in particular into certain public spaces (stores, train stations, airports, shopping malls, car parks, transportation systems, cafes, restaurants, etc.).

Access bases (also known as access points) have therefore been installed in certain areas. They are connected to a communications network, for example the Internet, and enable mobile terminal users in transit in these areas-to connect to the network.

In parallel with this, some professional and non-professional users, already connected to a fixed network but not having a connection of sufficiently high bit rate for comfortably exchanging large volumes of information (e.g. transferring or downloading large files) require the benefit of a high bit rate connection occasionally. These users may find it beneficial to use the above access bases.

There are at present several types of contactless (or wireless) connection technology that can be used with these access bases.

A first type of technology, based on exchanging information in the form of radio waves between the mobile terminal and the access base, includes Wi-Fi technology, for example, having access bases, known as “hot spots”, that are provided with radio transmit/receive means.

However, this technology causes problems of frequency congestion and interference with electronic equipment situated in the vicinity of the base. These problems may be acute in certain particular contexts, for example if the base is installed in an aircraft (interference with onboard equipment), in a hospital (interference with medical equipment), or in certain particular industrial environments.

A second type of technology that may be envisaged is based-on exchanging information in the form of unguided infrared optical radiation. At present, the main applications of this technology relate primarily to highly directional point-to-point communication of the free space optics (FSO) type adapted to connect two points spaced apart by a distance of a few hundred meters to a few thousand meters.

That technology relies on transmission by highly directional beams, since even slight divergence of the beam considerably limits transmission range, and is ill-adapted to the application envisaged, which relates to hot spot access bases, for which there is a different compromise to be achieved between coverage angle and range.

That infrared technology is also used in private networks, in particular for interconnecting different equipments provided with localized infrared transmit/receive means in domestic or business premises (“indoor” communications).

With that technology, high bit rate transmission makes it necessary to increase the radiated optical power, which could lead to infringing tolerances imposed by regulations.

An object of the invention is to provide wireless connection means enabling high bit rate communication.

To this end, the invention proposes a base for wireless connection of terminals to a communications network, said base including transmit/receive means adapted to exchange information with a remote terminal also provided with transmit/receive means, characterized in that the transmit/receive means of the base include a transmitter including an extended infrared light source.

The extended infrared source concept is defined by European Standard EN-60825-1 “Safety of laser products Part 1; Equipment classification, requirements and user's guide”. An extended infrared source means a source that is seen by an observer at a distance of 100 mm or greater at an angle greater than an angle αₘᵢₙ defined by the standard.

Using infrared provides a high bit rate contactless connection. The solution proposed by the invention increases the transmission bit rate compared to the fixed radio bases used at present by increasing the frequency of the carrier wave. With radio technologies, the transmission frequencies are predetermined and cannot be increased.

Using an extended source remains within the tolerances of the regulations in respect of ocular safety despite an overall increase in the emitted optical power compared to a point source.

Ocular safety standards are defined as a function of the size of the source and depend on wavelength: the more extensive the source, the greater the maximum authorized emitted power. Thus, at a wavelength of 1550 nanometers (nm), it is possible to multiply the emitted power relative to a point source by a factor of 1.5. At a wavelength of 810 nm that factor is 300.

The invention therefore achieves a good compromise between the dimensions of the area covered by the base and the transmission bit rate.

The optical base solution proposed by the invention is transparent to the exchange protocol used, because the invention is situated at the physical layer level, i.e. the first layer of the Open System Interconnection (OSI) reference model, used to set up physical connections between communicating electronic data processing equipments. That layer is compatible with the various protocols generally used for exchanging data such as Wi-Fi (i.e. 802.11 a, b, g or n), Ethernet, GigaEthernet, ATM, SDH, PDH, xSDL, IPv4 or IPv6.

The transmitter of the base is advantageously adapted to transmit information to a remote terminal at a high bit rate.

In the context of the present invention, the expression “high bit rate” means a bit rate exceeding 10 mega bits per second (Mbps) and as high as 1 giga bit per second (Gbps) or more.

Other features, aims, and advantages of the present invention become apparent on reading the following detailed description with reference to the appended drawings, which are provided by way of non-limiting example and in which:

FIG. 1 is a diagram of the general principle of operation of an optical base of the invention;

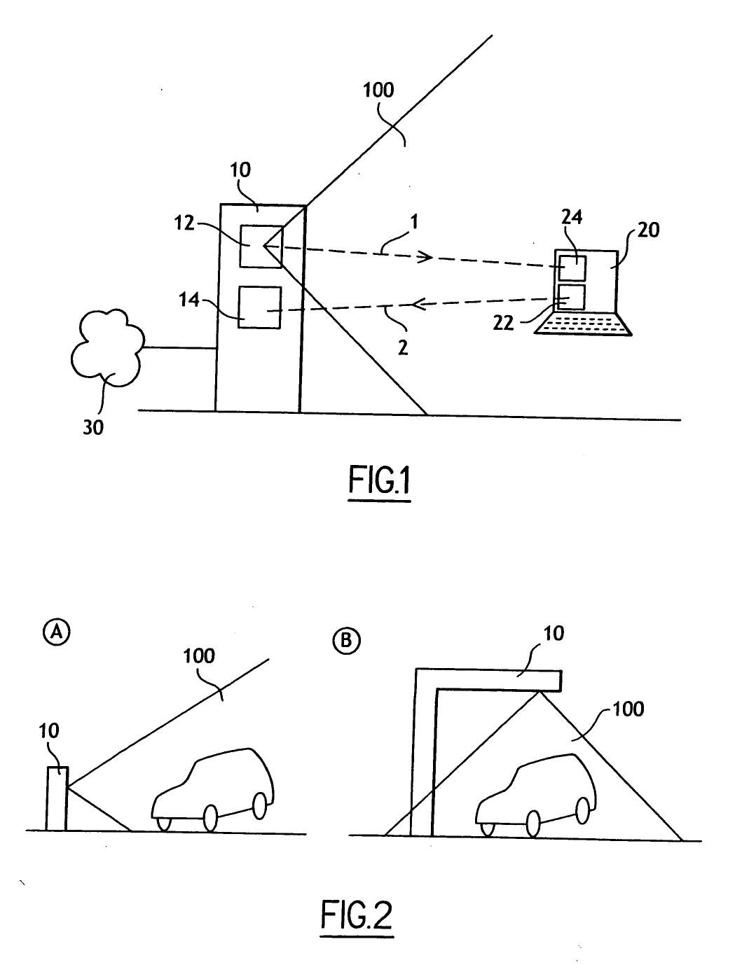

FIG. 2 is a diagram of one example of application of a base of the invention to a car park;

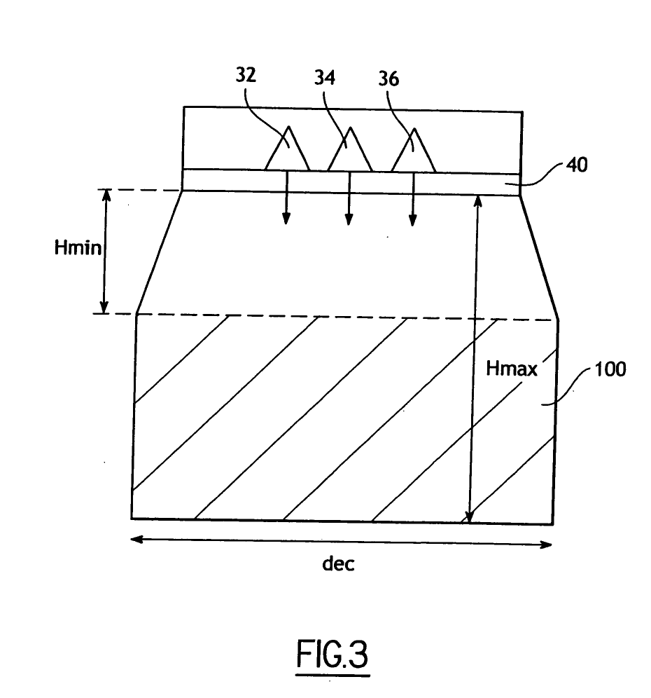

FIG. 3 is a diagram of the various components constituting an extended infrared source;

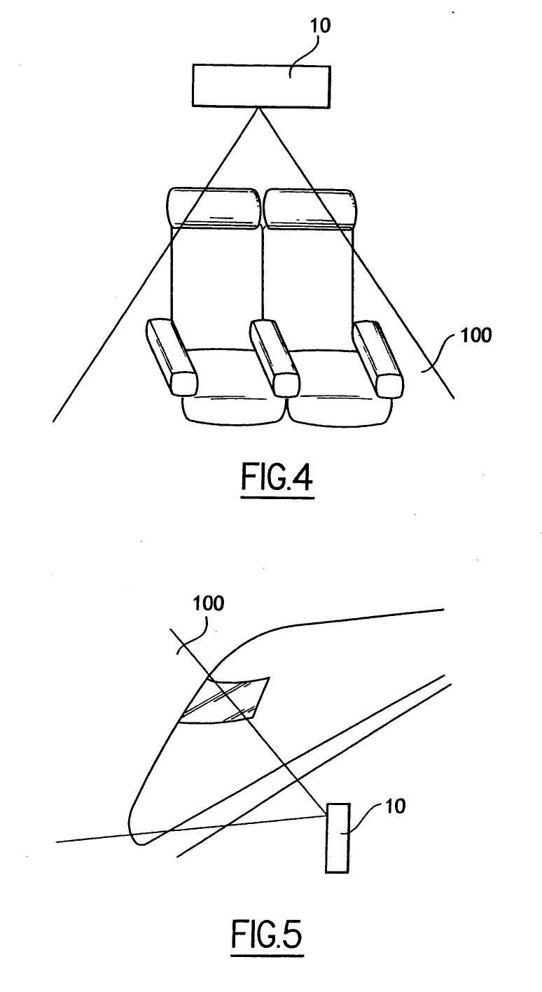

FIG. 4 is a diagram of an example of application of a base of the invention in a transport system;

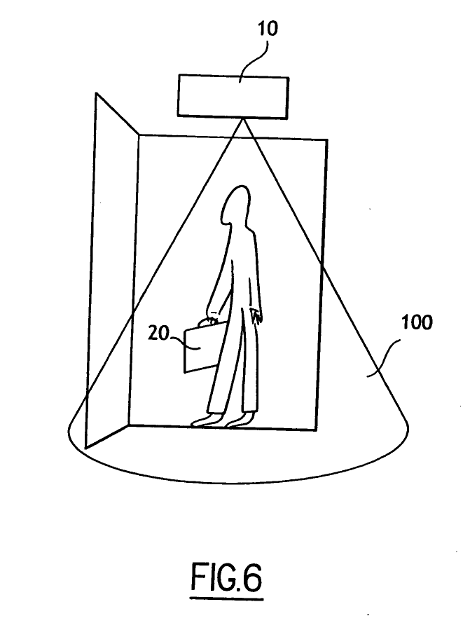

FIG. 5 shows an example of a base of the invention installed on a train station platform; and

FIG. 6 is a diagram of an example of application of a base of the invention usable by pedestrians.

In FIG. 1, an optical base 10 comprises transmit/receive means adapted to set up an optical connection with transmit/receive means of a mobile terminal 20 located inside a coverage area 100. The base 10 is connected to a communications network 30.

The transmit/receive means of the base 10 comprise a transmitter 12 and a receiver 14. The transmitter 12 includes an extended infrared light source.

In the coverage area 100 of the infrared source, the signal-to-noise ratio is compatible with the transmission envisaged.

Information 1 is transmitted from the base 10 to the terminal 20 over an infrared link having a line of sight that is direct, non-direct, or hybrid.

Information 2 may be transmitted from the terminal 20 to the base 10 over an infrared link that is direct, non-direct, or hybrid, as appropriate. In the case of a direct or hybrid link, the base 10 and the terminal 20 may include means for monitoring the positions of the source and the receiver to achieve optimum alignment of the source and the transmit/receive means of the terminal 20.

The receiver 14 of the base 10 is, for example, an omnidirectional receiver that comprises an omnidirectional concentrator. This omnidirectional concentrator may take the form of a hemispherical lens fitted with a hemispherical optical filter or a hemispherical lens with an anti-reflection surface treatment and a plane optical filter disposed in front of the receiver. The omnidirectional optical receiver 14 has a gain of 3 decibels (dB) or greater and a theoretical angular aperture of approximately 180 degrees.

In FIG. 2, an optical base 10 of the invention is installed in a car park. The base 10 includes an extended infrared source adapted to transmit optical signals and a receiver of a type compatible with the envisaged link. The base 10 transmits in a defined coverage area 100 in which the minimum signal-to-noise ratio compatible with the application and the error rate considered is achieved.

As can be seen in FIG. 2, the base 10 may have either of two configurations A and B in which the coverage area 100 constituting a communications space may be either horizontal (configuration A) or vertical (configuration B). In both cases, the communications space encompasses a parking space (a 3 m×5 m rectangle) and covers most modern motor vehicles (Hₘᵢₙ=1.5 m, Hₘₐₓ=3 m, d_{ec}=5 m). A user terminal is installed either on the exterior of the vehicle or inside the vehicle, behind a glazed surface (for example behind the windshield).

Table 1 sets out the main parameters of communication between the optical base and the user terminal for examples of application in a communications space using contactless (wireless) infrared line of sight non-direct links (WIr LOS-ND links).

The table lists the following parameters:
“Bit rate” refers to the bit rate of communication between transmitter and receiver required by the specific application envisaged;
“Ir window” refers to the infrared range of the optical carrier expressed in nanometers;
“Min. transmitted power” refers to the minimum power (in dBm) necessary for achieving a minimum signal-to-noise ratio in the communications space necessary for achieving the bit error rate (BER) required for a specific application;
“R(ψ)” designates the three-dimensional radiation model of the source (for example Lambertian model or special model);
“FOV” (Field of View) refers to the angular half-aperture of the transmitter or the receiver;
a receiver marked “No EQ” is a receiver without equalization in the reception process;
“Eff. area” means the effective area of the receiver complete with filter and hemispherical concentrator and PIN diode photodetector;
“Photodetector” (PIN) refers to a PIN diode photodetector;
“Area” refers to the area in cm² of the photodetector;
“Sensitivity” refers to the optical photodetection efficiency of the photodetector expressed in amperes per watt;
“Receiver sensitivity for min. S/N” refers to the minimum optical power impinging on the receiver needed to achieve a signal-to-electrical noise ratio required by a specific application;
“Optical filter” (hemispherical) refers to a bandpass filter deposited on or bonded to the hemispherical lens;
“Concentrator” (hemispherical) refers to a hemispherical lens with an omnidirectional optical gain of approximately n² (where n is the refractive index of the lens), which for the usual indices is equivalent to an optical gain of more than 3 dB;
“Car park EC” or “Train EC” refers to the communications space (EC) in a car park or in a train, having dimensions Hₘᵢₙ×Hₘₐₓ×d_{ec};
“WIr link” refers to a wireless infrared link of the LOS-ND type;
“Mod. Type” refers to the type of modulation of the online digital data, which is the On Off Keying/Non Return to Zero (OOK/NRZ) type;
“Channel type” refers to the digital optical channel used, which is of the Intensity Modulation/Direct Detection (IM/DD) type; and
“Free space attenuation” refers to the geometrical attenuation suffered by the optical beam between the transmitter and the receiver.

As can be seen in Table 1, the IM/DD infrared channel is in the 810 nm window and employs OOK/NRZ modulation. The bit rates available are 10, 100 and 155 Mbps, which are widely used in existing applications. This table shows that the transmit/receive components used in the base and mobile terminal envisaged are available with existing technologies.

FIG. 3 is a diagram of an extended infrared source of ocular safety class I that can be used in particular in the application represented in FIG. 1.

The extended infrared source includes laser transmitter means in the form of standard laser diodes 32, 34, 36 and transmission diffuser means 40 for diffusing the radiation emitted by the diodes 32, 34, 36. The transmission diffuser means 40 consist, for example, of a holographic diffuser which represents a simple solution of limited cost for the production of an extended source having a particular radiation pattern.

One embodiment of the source may include laser emitter means and reflector means for diffusing the radiation emitted by the laser emitter means.

Compared to point sources, using an extended source increases the maximum average power that can be emitted within constrains imposed by safety standards. The extended source is able to cover a larger communications space 100 and to achieve a maximum signal-to-noise ratio for the communication envisaged.

In the present example, the extended source is seen by an observer at an angle exceeding 100 milliradians, which in the case of an observer at a distance of 100 mm corresponds to a minimum diameter of 10 mm with an area of π/4 cm².

The maximum authorized average power in class I for 810 mm pulsed extended infrared sources used at high bit rates with an FOV of 60° is well above the minimum values set out in Table 1. There is therefore a reserve of power increase of the extended source that could be used to enlarge the communications space, to loosen the constraints on the performance of the components of the source, or to increase the bit rate of the source.

A signal-to-noise ratio compatible with the application considered is achieved throughout the communications space represented in FIG. 3 (the cross-hatched area 100). The communications space is substantially the shape of a cylinder of diameter d_{ec} defined by an upper plane at a distance Hₘᵢₙ from the source and a lower plane at a distance Hₘₐₓ from the source. The dimensions Hₘᵢₙ×Hₘₐₓ×d_{ec} of the communications space are specified for each application example in Tables 1 and 2.

The receiver of the base includes a filter, a hemispherical concentrator and a PIN diode photodetector with a large detection area (1 cm²) and medium sensitivity (0.53 amps per watt (A/W)). This type of receiver can offer an FOV of 70 degrees with a maximum gain of 3.5 dB. The necessary sensitivity of the receiver is calculated for a high level of background noise (5.8 μW/nm/cm²) and varies as a function of the bit rate from −40.5 dB.m (10 Mbps) to −34.5 dB.m (155 Mbps); achieving it represents no particular problem.

FIG. 4 shows an optical base 10 installed above passenger seats in a transport system such as a train, an aircraft, a ship, etc. The base is connected to a local area network on board the transport system. It is accommodated either in the ceiling or in an upper portion of a seatback facing the user's seat. In this type of application, the dimensions of the communications space covered by the base 10 are of the order of Hₘᵢₙ=0.5 m, Hₘₐₓ=1.5 m and d_{ec}=1.5 m.

Table 2 gives the main parameters of communication between the optical base and the user terminal in a communications space using wireless infrared line of sight non-direct (WIr LOS-ND) links. The parameters in this table are identical to those in Table 1.

FIG. 5 shows an optical base 10 installed on a train station platform. This horizontal base 10 enables information to be transferred between a fixed communications network and a local area network on board a train when the train is at the platform.

The possibilities of communication at very high bit rates with a terminal moving at high speed are limited, and it can be highly beneficial to transfer data bidirectionally between the transport system and the outside world during a stop. The transport system includes data storage means providing a buffer while in motion. Exchanges between the storage means and the base are carried out at a very high bit rate, in order to increase the volume of information concerned, and without contact or connection, in order to accelerate the process.

In the case of a stationary train, the dimensions of a horizontal or vertical communications space may be of the order of Hₘᵢₙ=1.5 m, Hₘₐₓ=3 m and d_{ec}=3 m. Using an exchange bit rate of 155 Mbps, it is feasible to transfer 30 Gbits of data during a stop of 3 minutes′duration.

This application may be generalized to other transport systems, such exchanges being effected in a car park or in an airport, for example. The data exchanged may be linked to the operation of the transport system (data exchanged by the transport system operator) or may comprise information coming from or intended for passengers in the context of a high-quality communications service.

FIG. 6 shows an optical base 10 installed in a public or private place reserved for pedestrians. This application enables pedestrians entering the space to connect their terminals 20 to a communications network. This application leads to different values of the parameters of the base compared to the other applications described above. Dimensions Hₘᵢₙ=1.5 m, Hₘₐₓ=3 m and d_{ec}=5 m may be suitable, for example.

TABLE 1

| | Horizontal (configuration A) | | | Vertical (configuration B) | | |
|---|---|---|---|---|---|---|
| Communications | Bit rate | | | | | |
| space - Car park | 10 Mbps | 100 Mbps | 155 Mbps | 10 Mbps | 100 Mbps | 155 Mbps |
| Ir window | 810 nm | 810 mm | 810 nm | 810 nm | 810 nm | 810 nm |
| Min. transmitted | +11 dBm | +17 dBm | +18 dBm | +16 dBm | +21 dBm | +22 dBm |
| power | | | | | | |
| Source type | Extended | Extended | Extended | Extended | Extended | Extended |
| R(ψ) | | | | | | |
| FOV | 60° | 60° | 60° | 60° | 60° | 60° |
| Receiver | No EQ | No EQ | No EQ | No EQ | No EQ | No EQ |
| Eff. area | 1.5 cm² | 1.5 cm² | 1.5 cm² | 1.5 cm² | 1.5 cm² | 1.5 cm² |
| FOV | 60° | 60° | 60° | 60° | 60° | 60° |
| Photodetector | PIN | PIN | PIN | PIN | PIN | PIN |
| Area | 1 cm² | 1 cm² | 1 cm² | 1 cm² | 1 cm² | 1 cm² |
| Sensitivity | 0.53 A/W | 0.53 A/W | 0.53 A/W | 0.53 A/W | 0.53 A/W | 0.53 A/W |
| Receiver | −40.5 dBm | −35.5 dBm | −34.5 dBm | −40.5 dBm | −35.5 dBm | −34.5 dBm |
| sensitivity for | | | | | | |
| 13.5 dB | | | | | | |
| min. S/N | | | | | | |
| Opt. filter | Hemisph. | Hemisph. | Hemisph. | Hemisph. | Hemisph. | Hemisph. |
| Bandwidth | 20 nm | 20 nm | 20 nm | 20 nm | 20 nm | 20 nm |
| Attenuation | −1.5 dB | −1.5 dB | −1.5 dB | −1.5 dB | −1.5 dB | −1.5 dB |
| Concentrator | Hemisph. | Hemisph. | Hemisph. | Hemisph. | Hemisph. | Hemisph. |
| Max. gain | +5 dB | +5 dB | +5 dB | +5 dB | +5 dB | +5 dB |
| Eff. area | 1.5 cm² | 1.5 cm² | 1.5 cm² | 1.5 cm² | 1.5 cm² | 1.5 cm² |
| FOV | 60° | 60° | 60° | 60° | 60° | 60° |
| Car park EC | 1 car | 1 car | 1 car | 1 car | 1 car | 1 car |
| Hₘᵢₙ × Hₘₐₓ × d_{ec} | 1.5 × 3 × 3 m³ | 1.5 × 3 × 3 m³ | 1.5 × 3 × 3 m³ | 1.5 × 3 × 3 m³ | 1.5 × 3 × 3 m³ | 1.5 × 3 × 3 m³ |
| WIr link | LOS-ND | LOS-ND | LOS-ND | LOS-ND | LOS-ND | LOS-ND |
| Mod. type | OOK/NRZ | OOK/NRZ | OOK/NRZ | OOK/NRZ | OOK/NRZ | OOK/NRZ |
| Channel type | IM/DD | IM/DD | IM/DD | IM/DD | IM/DD | IM/DD |
| Free space | −53 dB | −53 dB | −53 dB | −53 dB | −53 dB | −53 dB |
| attenuation | | | | | | |

TABLE 2

| | Vertical | | |
|---|---|---|---|
| Communications | Bit rate | | |
| space - Train | 10 Mbps | 100 Mbps | 155 Mbps |
| Ir window | 810 nm | 810 nm | 810 nm |
| Min. transmitted power | +7 dBm | +12 dBm | +13 dBm |
| Source type | Extended | Extended | Extended |
| R(ψ) | | | |
| FOV | 60° | 60° | 60° |
| Receiver | No EQ | no EQ | no EQ |
| Eff. area | 1.5 cm² | 1.5 cm² | 1.5 cm² |
| FOV | 60° | 60° | 60° |
| Photodetector | PIN | PIN | PIN |
| Area | 1 cm² | 1 cm² | 1 cm² |
| Sensitivity | 0.53 A/W | 0.53 A/W | 0.53 A/W |
| Receiver | −40.5 dBm | −35.5 dBm | −34.5 dBm |
| sensitivity for | | | |
| 13.5 dB | | | |
| min. S/N | | | |
| Opt. filter | Hemisph. | Hemisph. | Hemisph. |
| Bandwidth | 20 nm | 20 nm | 20 nm |
| Attenuation | −1.5 dB | −1.5 dB | −1.5 dB |
| Concentrator | Hemisph. | Hemisph. | Hemisph. |
| Max. gain | +5 dB | +5 dB | +5 dB |
| Eff. area | 1.5 cm² | 1.5 cm² | 1.5 cm² |
| FOV | 60° | 60° | 60° |
| Train EC | 2 seats | 2 seats | 2 seats |
| Hₘᵢₙ × Hₘₐₓ × d_{ec} | 0.5 × 1.5 × 1.5 m³ | 0.5 × 1.5 × 1.5 m³ | 0.5 × 1.5 × 1.5 m³ |
| WIr link | LOS-ND | LOS-ND | LOS-ND |
| Mod. type | OOK/NRZ | OOK/NRZ | OOK/NRZ |
| Channel type | IM/DD | IM/DD | IM/DD |
| Free space | −46.5 dB | −46.5 dB | −46.5 dB |
| attenuation | | | |

1. A base for wireless connection of terminals to a communications network, said base including transmit/receive means adapted to exchange information with a remote terminal also provided with transmit/receive means, wherein the transmit/receive means of the base include a transmitter including an extended infrared light source.

2. An optical base according to claim 1, wherein the transmitter of the base is adapted to transmit information to a remote terminal at a high bit rate.

3. A base according to claim 1, further comprising source position control means for obtaining optimum alignment of the source and the transmit/receive means of a terminal located in the coverage area of the base.

4. A base according to claim 1, wherein the extended infrared source includes laser emitter means and transmission diffuser means for diffusing radiation emitted by the laser emitter means.

5. A base according to claim 4, wherein the transmission diffuser means are of the holographic type.

6. A base according to claim 1, wherein the extended infrared source includes laser emitter means and reflector means for diffusing radiation emitted by the laser emitter means.

7. A base according to claim 1, wherein the transmit/receive means of the base include an omnidirectional receiver.

8. A base according to claim 7, wherein the omnidirectional receiver includes at least an omnidirectional concentrator.

9. A base according to claim 8, wherein the omnidirectional concentrator is hemispherical and includes an optical filter.

10. A base according to claim 8, wherein the omnidirectional concentrator has been subjected to an anti-reflection surface treatment.

11. A method of wireless communication between a base for connection to a communications network and a remote terminal, said base including transmit/receive means adapted to exchange information with said terminal, which is also provided with transmit/receive means, wherein the method comprises transmitting information with the transmit/receive means of the base to said terminal by means of a transmitter including an extended infrared light source.

12. A method according to claim 11, wherein information is transmitted from the base to said terminal over an infrared link having a line of sight that is direct, non-direct, or hybrid.

13. A method according to claim 11, wherein the transmit/receive means of said terminal transmit information to the base over an infrared link having a line of sight that is direct or non-direct.

14. A method according to claim 11, wherein the information is transmitted between said terminal and the base in burst mode.
